(19) United States
(12) Patent Application Publication
(10) Pub. No.: US 2008/0212096 A1
(43) Pub. Date: Sep. 4, 2008

(54) PROPERTY DETERMINATION WITH LIGHT IMPINGING AT CHARACTERISTIC ANGLE

(76) Inventor: Deepak Kumar, Portland, OR (US)

Correspondence Address: FISH & RICHARDSON P.C., P.O. BOX 1022, MINNEAPOLIS, MN, 55440-1022, US

(21) Appl. No.: 11/680,993

(22) Filed: Mar. 1, 2007

(51) Int. Cl. G01J 4/00

(52) U.S. Cl. 356/369

(57) ABSTRACT

A method for determining a property of a layered structure includes receiving information defining a characteristic angle for a structure. The characteristic angle is such that, after performance of a process that changes a thickness of a first layer adjacent a second layer of the structure, light reflected from a beam that impinges at the characteristic angle on an interface that will be formed adjacent the second layer has predominantly a first polarization. After receiving the information and during the process, a light beam is directed onto the structure at the characteristic angle. The light beam includes at least a first component having the first polarization and a second component having a second polarization. Light that the structure reflects from the light beam is detected. A signal is generated upon detecting that a proportion of the reflected light that has the first polarization undergoes a change meeting a predefined criterion.

### TECHNICAL FIELD

This document relates to determining a property of a structure.

### BACKGROUND

There are many situations in which light rays can be used for determining a physical characteristic of a material. For example, it is sometimes desirable to measure the thickness of a layer that is deposited on top of a substrate. That is, when a layer on top of a substrate is being planarized or otherwise partially removed in a polishing process, one may want to determine (directly or indirectly) the remaining thickness so that too much material is not removed. As another example, when a layer is being deposited on a substrate, one may want to determine (directly or indirectly) the deposited thickness so that too much or too little of the layer material is not deposited. Thus, the purpose of determining the thickness in some situations may be to determine a desired end point of a manufacturing process. In other examples, a physical characteristic such as thickness may be determined for quality control, classification, calibration, compatibility testing, or other purposes.

Several methods have been developed for in-situ polishing endpoint detection. Some of these methods may involve monitoring a parameter associated with the substrate surface, and indicating an endpoint when the parameter abruptly changes. For example, where an isolative or dielectric layer is being polished to expose an underlying metal layer, the coefficient of friction and the reflectivity of the substrate will change abruptly when the metal layer is exposed. Other endpoint detection methods involve impinging a light beam on the substrate and analyzing the light that reflects off the surface. Such analyses may involve monitoring interference fringes in the reflected light or registering how reflectance varies with an angle of incident polarized light.

### SUMMARY

The invention relates to determining a property of a layered structure.

In a first general aspect, a method for determining a property of a layered structure includes directing a light beam, during a process that changes a thickness of a first layer adjacent a second layer of a structure, onto the structure at a characteristic angle for the structure. The light beam includes at least a first component having a first polarization and a second component having a second polarization. The characteristic angle is such that, after performance of the process, light reflected from a beam that impinges at the characteristic angle on an interface that will be formed adjacent the second layer has predominantly the first polarization. The method includes detecting light that the structure reflects from the light beam. The method includes generating a signal upon detecting that a proportion of the reflected light that has the first polarization undergoes a change that meets a predefined criterion.

Implementations can include any or all or none of the following features. The second polarization can be used to normalize the first polarization. The first polarization and the second polarization can be essentially orthogonal. The first polarization can be an s-polarization and the second polarization can be a p-polarization, and the change that meets the predefined criterion can be an increase in the s-polarization as the interface is formed adjacent the second layer. The change can be detected using a ratio between the s-polarization and the p-polarization. The first layer can be a dielectric film. The second layer can be a material selected from the group consisting of: a dielectric film and a wafer. Before the process is performed, a determination can be performed of what the interface that will be formed adjacent the second layer will be. The characteristic angle can be a Brewster's angle for the determined interface. The interface can be formed by at least partial removal of the first layer during the process. The interface can include a boundary between the second layer and at least one selected from the group consisting of: the first layer, air, vacuum, slurry and combinations thereof. The interface can be formed by deposition of the first layer on the second layer during the process, and the interface can include a boundary between the second layer and the first layer. There can be detected, in the reflected light, a contribution of first-polarization light generated by the first layer that is distinguishable from a contribution from the second layer. The predefined criterion can include the contribution from the first layer reaching a certain proportion of the reflected light. The light beam can be directed onto the structure through at least one pinhole. The signal can be generated to stop the performance of the process.

In a second general aspect, an apparatus for determining a property of a layered structure includes a light source that directs a light beam onto a structure at a characteristic angle. The light beam includes at least a first component having a first polarization and a second component having a second polarization, the characteristic angle being such that, after performance of a process that changes a thickness of a first layer adjacent a second layer of the structure, light reflected from the light beam impinging on an interface that will be formed adjacent the second layer has predominantly a first polarization. The apparatus includes a sensor that receives the reflected light. The apparatus includes a processor configured to generate a signal upon detecting that a proportion of the reflected light that has the first polarization undergoes a change that meets a predefined criterion.

Implementations can include any or all or none of the following features. The first polarization can be an s-polarization and the second polarization can be a p-polarization, and wherein the change that meets the predefined criterion is an increase in the s-polarization as the interface is formed adjacent the second layer. The light source can direct the light beam onto the structure through at least one pinhole. The first layer can be a dielectric film on top of the second layer, the dielectric film to be at least partially removed in the process; the interface that will be formed can include a boundary between the second layer and at least one selected from the group consisting of: the first layer, air, vacuum, slurry and combinations thereof; and the characteristic angle can be a Brewster's angle for the interface.

The present invention can be implemented to provide some, all, or none of the following advantages. Providing improved detection of a layer property. Providing improved endpoint detection by indicating the exposure of an underlying layer. Providing improved endpoint detection by indicating the successful covering of a previously exposed layer.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic representation of an optical detection system.

FIG. 2 is a graph of reflectance as a function of angle of incidence.

FIG. 3 is a side view of an optical detection component.

FIG. 4 shows an example process of optical detection.

FIG. 5 is a side view of a chemical mechanical polishing apparatus including an optical detection component.

FIG. 6 is a block diagram of a computer system.

Like reference symbols in the various drawings indicate like elements.

### DETAILED DESCRIPTION

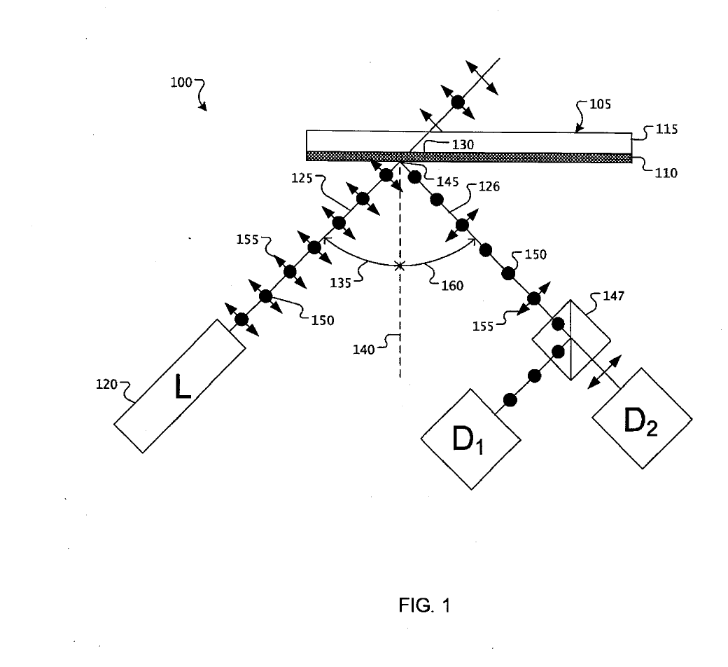

FIG. 1 is a schematic representation of an optical detection system 100, for example implemented for monitoring a chemical mechanical polishing (CMP) process performed on a layered structure 105, such as a substrate. In the current implementation, the layered structure 105 includes a layer 110 and a layer 115. For example, the layer 110 can be a thin film dielectric layer and can be formed from an oxide, for example silicon oxide. The layer 115 can be a dielectric layer and can have a different index of refraction than the layer 110. The layer 115 can be formed from a nitride, for example silicon nitride, or it can be the substrate itself, such as a silicon wafer or a glass sheet, to name a few examples. For example in polishing step of a shallow trench isolation process, the outer layer 110 can be silicon oxide and the inner layer 115 can be silicon nitride. In this implementation, the optical detection system 100 can determinate a property of the layered structure by monitoring one or more interfaces in the layered structure 105. For example, when the layer 110 is sought to be removed in whole or in part, an interface between the layer 115 and the surrounding of the substrate 105 can be monitored. As another example, when the layer 110 is being built up on the layer 115, the interface between the layer 115 and the layer 110 can be monitored. Assume that the layer 110 is being removed in the present implementation, and that the system 100 seeks to determine the point in time when this process is substantially complete (i.e., and endpoint determination).

The optical detection system 100 includes a light source 120 that can direct a beam of light 125 at an angle of incidence 135 to the bottom surface of the layered structure 105 from the side of the structure 105 that is being processed. For example, the light source includes a laser. The beam of light here passes through the layer 110 and impinges on an interface 130 formed between the layer 110 and the layer 115. An angle of incidence 135 is the angle formed between the beam of light 125 and a line 140 that is perpendicular to the interface 130 at a point of incidence 145, called the normal. A surface normal, or just normal, to a flat surface is a three-dimensional vector which is perpendicular to that surface.

The beam of light 125 from the light source 120 here is a laser beam that contains two orthogonal polarizations, an s-polarization 150, and a p-polarization 155. The s-polarization 150 is substantially parallel to the interface 130 and the p-polarization 155 is substantially perpendicular to the s-polarization 150. The system 100 monitors the respective proportions of these components in light reflected from the substrate to decide when the process is complete, as will be described.

The beam of light 125 is partially reflected from the interface 130 of the layered structure 105 at an angle of refraction 160. [FIG. 1 shows the light reflected from the exposed surface of 110, not the interface between 110 and 115] The angle of refraction 160 is the angle formed between the portion of the beam of light 125 that is reflected and the normal 140. Reflection is the change in the direction of a wave front at an interface between two dissimilar media so that the wave front returns into the medium from which it originated.

Using a polarizing beam splitter 147 the reflectances of the two orthogonal polarizations 150 and 155 present in the reflected portion of the light beam can be separated. The reflected s-polarization 150 is received by a detector D1, and the reflected p-polarization 155 is received by a detector D2. For example, the detectors D1 and D2 can use photodiodes to detect the intensity of the portion of the reflected light beam. The detection of the light intensity for the reflectances of the two orthogonal polarizations 150 and 155 can reduce the effect of fluctuations in the intensity of the portion of the beam of light 125 reflected.

Still referring to FIG. 1, the ratio of the reflectance of the s-polarization 150 to the reflectance of the p-polarization 155 can be determined. Repeated evaluation of this ratio can allow the system to determine the progress of the process (such as a CMP process) or the rate of removal of the layer 110, to name two examples. In another implementation, the layer 110 can be in the process of being built up on the layer 115. In such an implementation, a change in the ratios of the reflectances can indicate that the buildup has indeed reached a desired thickness.

By monitoring the ratio of the polarizations 150 and 155 in the beam of light 165 reflected from the interface 130 of the layered structure 105, the optical detection system 100 can accurately detect the endpoint of the CMP process. For the interface 130, there can be defined an incident angle at which the reflected light contains very little or none of the p-polarization 155, and consequently consists only, or predominantly, of the s-polarization 150. Such an angle is sometimes referred to as the Brewster's angle. For example, the Brewster's angle can be defined for the interface between, on one hand, the layer 115 and, on the other, the surrounding material (such as vacuum, air or polishing slurry). When light impinges at this angle, then, and at the time when the layer 110 has been substantially removed, then the reflected light will consist essentially (or exclusively) of the s-polarization 150. Thus, the ratio of the intensity of the two polarizations 150 and 155 can indicate that the lower layer (for example, the layer 115) is exposed during the CMP process.

The indices of refraction for the respective layers 110 and 115 can be determined by known techniques, such as with a refractometer, or assuming that the composition of the layers is known, by reference to . In general, a dielectric layer can have a refractive index between about 1.4 and 3. For example, silicon oxide can have a refractive index of about 1.46, and silicon nitride can have a refractive index of about 2.05. In one implementation, the index of refraction of layer 110 is less than the index of refraction of layer 115.

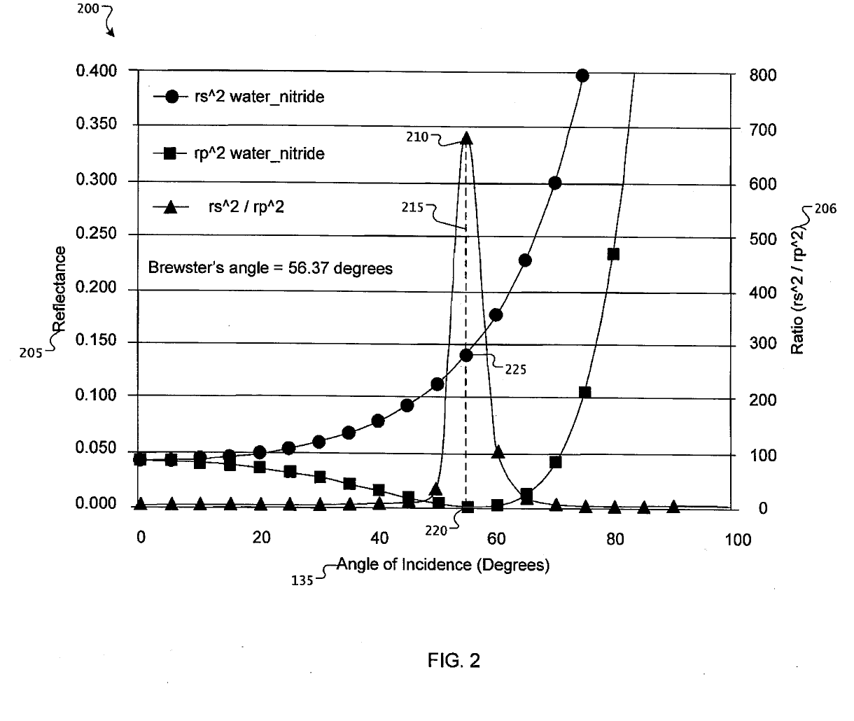

FIG. 2 is a graph 200 of a reflectance 205 and a ratio 206 as a function of the angle of incidence 135 for the s-polarization 150 and the p-polarization 155. The reflectance for the s-polarization is indicated with filled circles in the graph and can be measured by the detector D1; the reflectance for the p-polarization is indicated with filled squares in the graph and can be measured by the detector D2. The interface 130 is here a water-nitride interface. The ratio 206 is referred to as rŝ2/rp̂2 between the reflectances of the s-polarization 150 and the p-polarization 155 and is indicated by filled triangles in the graph. The ratio reaches a maximum value 210 when the angle of incidence 135 is equal to a Brewster's angle 215 for the water-nitride interface. In the current implementation, the Brewster's angle for the water-nitride interface is about 56.37 degrees. Since the refractive index for a given medium changes depending on the wavelength of light, the Brewster's angle 215 will also vary with wavelength.

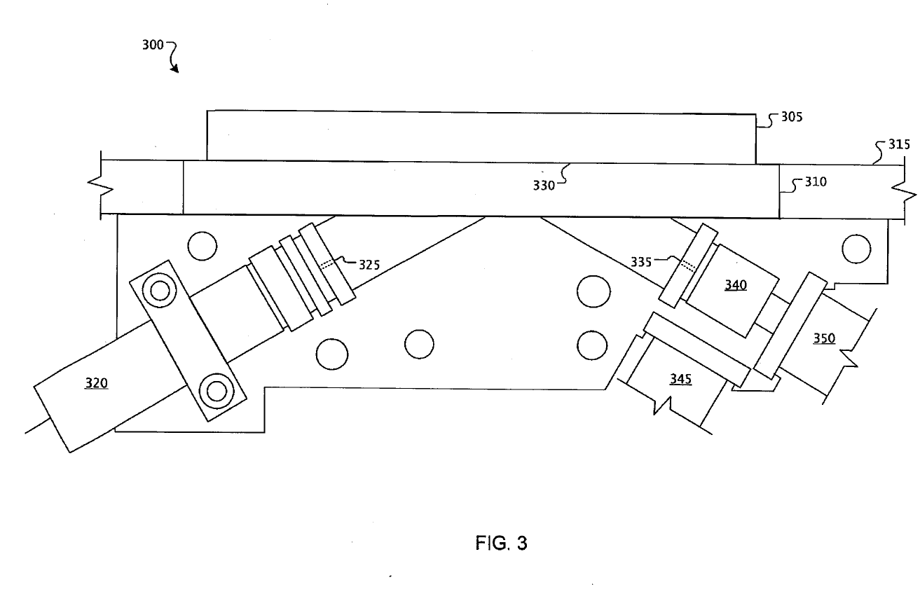

FIG. 3 is a side view of an optical detection component 300 that can be used for determining a surface property of a layered structure 305. For example, the layered structure 305 can include the layers 110 and 115 discussed above. Here, the layered structure 305 is separated from the measurement side of the component 300 by a transparent layer 310. The transparent layer 310 can be included in a platen 315 upon which the layered structure 305 rests. For example, when the polishing process involves rotating one of the structure 305 and the platen 315 relative to each other, the substrate can pass over the window (as seen from the measurement side of the apparatus) at regular intervals, such as once in every rotation.

The optical detection component 300 includes a light source 320 that can direct a light beam (not shown) onto the layered structure 305 at a characteristic angle. The light source can be similar to the laser described above. The light beam impinges on an interface 330 between the transparent layer 310 and the substrate 305. Here, the substrate 305 essentially abuts the transparent layer 310. This means that when the covering layer has been substantially removed in the polishing, the remaining interface 330 will be between the transparent layer 310 and the underlying (i.e., non-removed) layer of the substrate 305. The characteristic angle can then be defined based on that characteristic of the interface 330. The layer being removed from the substrate 305 can be a dielectric film. The non-removed layer can be a dielectric film or it can be the base material of the substrate.

The characteristic angle is such that, after the performance of a process that changes the thickness of the first layer 310 adjacent to the second layer 315, the light reflected from the light beam impinging on the interface 330 that will be formed adjacent to the second layer 315 has predominantly the first polarization. The interface 330 that will be formed comprises a boundary between the second layer 315 and at least one selected material from the group that can include the first layer 310, air, vacuum, slurry, or combinations thereof.

The light source 320 directs the beam of light onto the structure through a first pinhole 325. The optical detection component 300 includes a second pinhole 335 through which the reflected beam of light passes. The pinhole(s) can seek to ensure that only the intended light beam impinges on the interface and/or is reflected into the detector(s). Thus, the pinhole(s) can serve to keep ambient light out of the sensitive areas of the measurement apparatus. This can be important because otherwise the proportions of polarization components in the reflected light can be inadvertently altered.

The beam of light is received by a polarizing beam splitter 340 that separates and directs the first and second polarizations present in the reflected beam of light to one or more sensors 345 and 350. For example, the sensors 345 and 350 can include the detector D1 and the detector D2 of FIG. 1, respectively. The sensors 345 and 350 can be connected to a processor (not shown) that is configured to generate a signal upon detecting that a proportion of the reflected light that has the first polarization undergoes a change that meets a predefined criterion. In this implementation, the change that meets the predefined criterion is an increase in the s-polarization 150 as the interface is formed adjacent the second layer 315. For example, the processor can generate a signal upon detecting that the proportion (i.e., ratio) of the s-polarization 150 to the p-polarization 155 (i.e., rŝ2/rp̂2 in FIG. 2) in the reflected light is substantially equal to the maximum value 210 in FIG. 2.

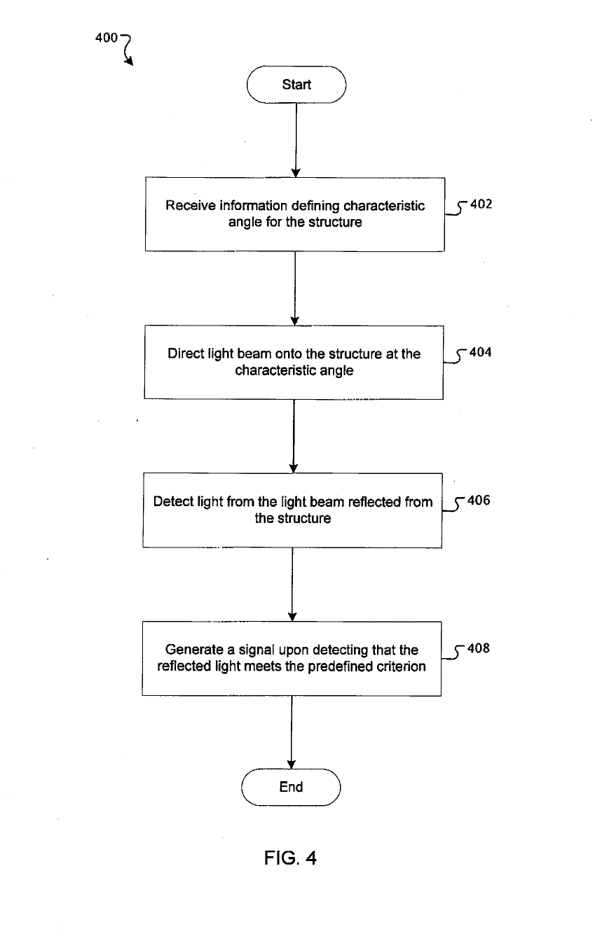

FIG. 4 shows an example process 400 of optical endpoint detection that can be used to determine a property of a layered structure. The process 400 can be implemented by a computer program product that is stored by an information carrier.

In optional step 402, information defining the characteristic angle for the structure is received. The characteristic angle is defined such that a portion of a beam of light reflected from the beam of light that impinges at the characteristic angle upon the interface predominantly includes the first polarization. For example, the characteristic angle is the Brewster's angle for the determined interface. The first layer can be, for example, a dielectric film. For example, this information can be received when a machine practicing the process 400 is manufactured or configured.

During the process, a light beam is directed onto the structure at the characteristic angle in step 404. The light beam includes at least a first component having the first polarization and a second component having a second polarization. For example, the light beam is directed onto the layered structure 305 through the first pinhole 325.

In step 406, light that the structure reflects from the light beam is detected. For example, the detectors D1 and D2 (or detectors 345 and 350) can detect the reflected light.

In step 408, a signal is generated upon detecting that a proportion of the reflected light that has the first polarization undergoes a change that meets a predefined criterion. For example, the proportion of p-polarized light can substantially vanish when the dielectric layer has been removed. As has been discussed above, this is because the light beam impinges at the Brewster's angle for the interface that is formed when the dielectric layer is substantially removed; for example an interface between an underlying layer and a transparent window, slurry, air or vacuum. For example, the signal is an endpoint determination and can be used to terminate the polishing process.

The following is another example illustrating the step 408. The sensors 345 and 350 can be connected to a processor that generates a signal upon detecting that a proportion of the reflected light that has the first polarization undergoes a change such that the reflected light meets the predefined criterion. Further, the processor detects, in the reflected light, a contribution of first-polarization light that is generated by the dielectric layer and that is distinguishable from a contribution from the second layer 315. As previously mentioned, the predefined criterion can include the reflected light from the first layer reaching a certain proportion of the reflected light. When the reflected light from the dielectric layer reaches the certain proportion, the signal that is generated is a stop signal that indicates that the performance of the process has reached the endpoint. Additional steps can be performed in the method 400. Some or all steps can be performed more than once.

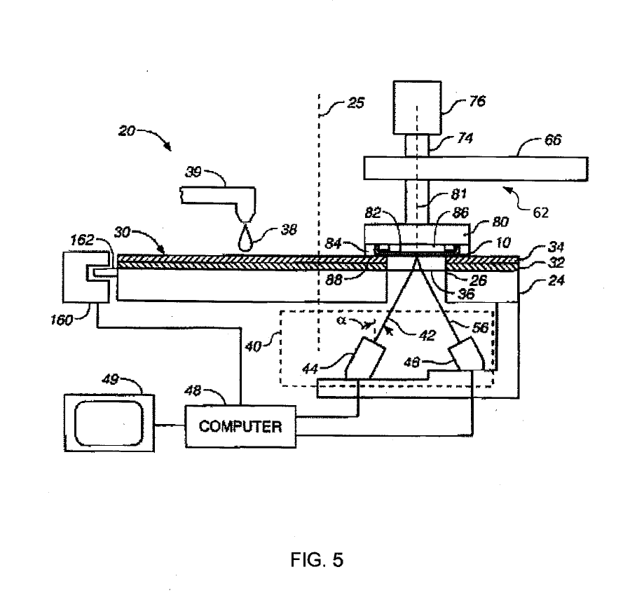

It has been described above that a polishing system is one implementation where the systems and techniques taught herein can be used. An example of such a system will therefore be described. FIG. 5 is a side view of a chemical mechanical polishing (CMP) apparatus 20 including an optical detection system 40. A substrate 10 can be polished by the CMP apparatus 20. A description of a similar polishing apparatus may be found in U.S. Pat. No. 5,738,574, the entire disclosure of which is incorporated herein by reference.

The CMP apparatus 20 includes a rotatable platen 24 on which is placed a polishing pad 30. The polishing pad 30 may include two-layers with a hard durable outer surface, for example, for initial material removal, planarization, or both. Alternatively, the polishing pad 30 may include a relatively soft single layer pad, for example, for final polishing. If the substrate 10 is an “eight-inch” (200 millimeter) or “twelve-inch” (300 millimeter) diameter disk, then the platen 24 and polishing pad 30 will be about twenty inches or thirty inches in diameter, respectively. The platen 24 may be connected to a platen drive motor (not shown). For most polishing processes, the platen drive motor rotates the platen 24 at thirty to two hundred revolutions per minute, although lower or higher rotational speeds may be used. The CMP apparatus 20 may also include a pad conditioner apparatus 28 to maintain the condition of the polishing pad 30 so that the polishing pad 30 will effectively planarized and/or polish the substrate 10.

The polishing pad 30 typically has a backing layer 32 which abuts the surface of the platen 24 and a covering layer 34 which is used to polish the substrate 10. The covering layer 34 is typically harder than the backing layer 32. However, some of the polishing pads 30 have only the covering layer 34 and do not have the backing layer 32. The covering layer 34 may be composed of an open cell foamed polyurethane or a sheet of polyurethane with a grooved surface. The backing layer 32 may be composed of compressed felt fibers leached with urethane. For example, a two-layer polishing pad 30, with the covering layer 34 composed of IC-1000 and the backing layer 32 composed of SUBA-4, is available from Rodel, Inc., of Newark, Del. (IC-1000 and SUBA-4 are product names of Rodel, Inc.).

Still referring to FIG. 5, the CMP apparatus 20 includes a carrier head system 62 with a carrier head 80 supported by a carousel support plate 66. A carrier drive shaft 74 connects a carrier head rotation motor 76 to the carrier head 80 so that the carrier head 80 can independently rotate about a central axis 81. The carrier head 80 performs several mechanical functions. Generally, the carrier head 80 holds the substrate 10 against the polishing pad 30, evenly distributes a downward pressure across the back surface of the substrate 10, transfers torque from the carrier drive shaft 74 to the substrate 10, and ensures that the substrate 10 does not slip out from beneath the carrier head 80 during polishing operations.

The carrier head 80 may include a flexible membrane 82 that provides a mounting surface for the substrate 10, and a retaining ring 84 to retain the substrate 10 beneath the mounting surface. The pressurization of a chamber 86 defined by the flexible membrane 82 forces the substrate 10 against the polishing pad 30. The retaining ring 84 may be formed of a highly reflective material, or it may be coated with a reflective layer to provide it with a reflective lower surface 88. A description of a similar carrier head may be found in U.S. patent application Ser. No. 08/745,679, entitled a CARRIER HEAD WITH a FLEXIBLE MEMBRANE FOR a CHEMICAL MECHANICAL POLISHING SYSTEM, filed Nov. 8, 1996, by Steven M. Zuniga et al., assigned to the assignee of the present invention, the entire disclosure of which is incorporated herein by reference.

A slurry 38 containing a reactive agent (e.g., deionized water for oxide polishing) and a chemically-reactive catalyzer (e.g., potassium hydroxide for oxide polishing) may be supplied to the surface of polishing pad 30 by a slurry supply port or combined slurry/rinse arm 39. If the polishing pad 30 is a standard pad, the slurry 38 may also include abrasive particles (e.g., silicon dioxide for oxide polishing).

In operation, the platen 24 is rotated about a central axis 25 while the carrier head 80 is simultaneously rotated about the central axis 81 and translated laterally across the surface of the polishing pad 30. A hole 26 is formed in the platen 24 and a transparent window 36 is formed in a portion of the polishing pad 30 overlying the hole 26. The transparent window 36 may be constructed as described in U.S. patent application Ser. No. 08/689,930, entitled METHOD OF FORMING A TRANSPARENT WINDOW IN A POLISHING PAD FOR A CHEMICAL MECHANICAL POLISHING APPARATUS by Manoocher Birang, et al., filed Aug. 26, 1996, and assigned to the assignee of the present invention, the entire disclosure of which is incorporated herein by reference. The hole 26 and the transparent window 36 are positioned such that they have a view of the substrate 10 during a portion of the platen's 24 rotation, regardless of the translational position of the carrier head 80.

An optical detection system 40, e.g., a laser detection system, is secured to the platen 24 generally beneath the hole 26 and rotates with the platen 24. The optical detection system 40 includes a light source 44 and a detector 46. The light source 44 generates a light beam 42 which propagates through the transparent window 36 and the slurry 38 to impinge upon the exposed surface of the substrate 10. For example, the light source 44 may be a laser and the light beam 42 may be a collimated laser beam. The light beam 42 is projected from light source 44 at an angle \acute{α} from an axis normal to the surface of substrate 10, i.e., at an angle \acute{α} from axes 25 and 81. In addition, if the hole 26 and the window 36 are elongated, a beam expander (not illustrated) may be positioned in the path of the light beam 42 to expand the light beam 42 along the elongated axis of the window 36. The light source 44 may operate continuously. Alternately, the light source 44 may be activated to generate the light beam 42 during a time when the hole 26 is generally adjacent to the substrate 10.

Still referring to FIG. 5, the CMP apparatus 20 may include a position sensor 160, such as an optical interrupter, to sense when the window 36 is near the substrate 10. For example, the position sensor 160 could be mounted at a fixed point opposite the carrier head 80. A flag 162 is attached to the periphery of the platen 24. The point of attachment and the length of the flag 162 are selected such that the flag 162 interrupts the optical signal of the position sensor 160 from a time shortly before the window 36 sweeps beneath the carrier head 80 to a time shortly thereafter. The output signal from the detector 46 may be measured and stored while the optical signal of sensor 160 is interrupted.

For compatibility with the endpoint detection techniques discussed in U.S. patent application Ser. No. 08/689,930, the flag 162 may have regions of differing widths, and the position sensor 160 could have multiple optical interrupters. For example, one interrupter would be used for process characterization using monitor wafers discussed below, and the other interrupter would be used for endpoint detection during polishing of product wafer.

In operation, the CMP apparatus 20 uses the optical detection system 40 to determine the amount of material removed from the surface of the substrate 10, or to determine when the surface of the substrate 10 has become planarized. A general purpose programmable digital computer 48 may be connected to the light source 44, the detector 46 and the position sensor 160. The computer 48 may be programmed to activate the light source 44 when the substrate 10 generally overlies the window 36, to store intensity measurements from the detector 46, to display the intensity measurements on an output device 49, to calculate the initial thickness, polishing rate, amount removed and remaining thickness from the intensity measurements, and to detect the polishing endpoint.

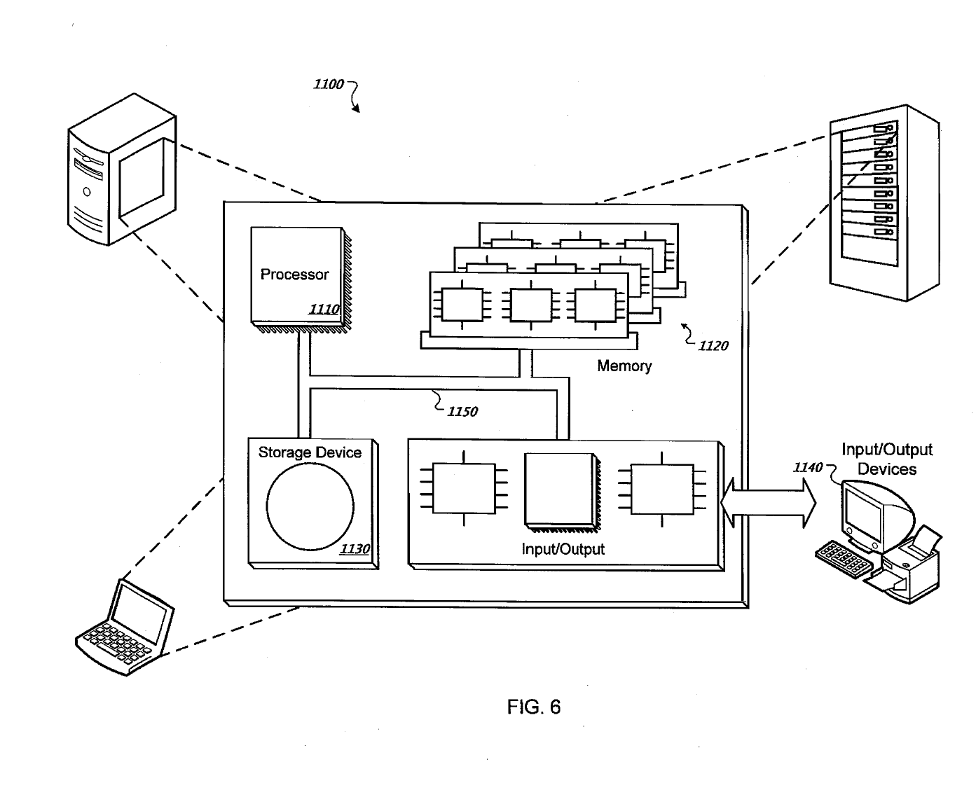

FIG. 6 is a schematic diagram of a generic computer system 1100. The system 1100 can be used for the operations described in association with any of the computer-implement methods described previously, according to one implementation. The system 1100 includes a processor 1110, a memory 1120, a storage device 1130, and an input/output device 1140. Each of the components 1110, 1120, 1130, and 1140 are interconnected using a system bus 1150. The processor 1110 is capable of processing instructions for execution within the system 1100. In one implementation, the processor 1110 is a single-threaded processor. In another implementation, the processor 1110 is a multi-threaded processor. The processor 1110 is capable of processing instructions stored in the memory 1120 or on the storage device 1130 to display graphical information for a user interface on the input/output device 1140.

The memory 1120 stores information within the system 1100. In one implementation, the memory 1120 is a computer-readable medium. In one implementation, the memory 1120 is a volatile memory unit. In another implementation, the memory 1120 is a non-volatile memory unit.

The storage device 1130 is capable of providing mass storage for the system 1100. In one implementation, the storage device 1130 is a computer-readable medium. In various different implementations, the storage device 1130 may be a floppy disk device, a hard disk device, an optical disk device, or a tape device.

The input/output device 1140 provides input/output operations for the system 1100. In one implementation, the input/output device 1140 includes a keyboard and/or pointing device. In another implementation, the input/output device 1140 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method for determining a property of a layered structure, the method comprising:
directing a light beam, during a process that changes a thickness of a first layer adjacent a second layer of a structure, onto the structure at a characteristic angle for the structure, the light beam including at least a first component having a first polarization and a second component having a second polarization, the characteristic angle being such that, after performance of the process, light reflected from a beam that impinges at the characteristic angle on an interface that will be formed adjacent the second layer has predominantly the first polarization;
detecting light that the structure reflects from the light beam; and
generating a signal upon detecting that a proportion of the reflected light that has the first polarization undergoes a change that meets a predefined criterion.

2. The method of claim 1, further comprising using the second polarization to normalize the first polarization.

3. The method of claim 1, wherein the first polarization and the second polarization are essentially orthogonal.

4. The method of claim 3, wherein the first polarization is an s-polarization and the second polarization is a p-polarization, and wherein the change that meets the predefined criterion is an increase in the s-polarization as the interface is formed adjacent the second layer.

5. The method of claim 4, wherein the change is detected using a ratio between the s-polarization and the p-polarization.

6. The method of claim 1, wherein the first layer is a dielectric film.

7. The method of claim 1, wherein the second layer is a material selected from the group consisting of: a dielectric film and a wafer.

8. The method of claim 1, further comprising performing, before the process is performed, a determination of what the interface that will be formed adjacent the second layer will be.

9. The method of claim 8, wherein the characteristic angle is a Brewster's angle for the determined interface.

10. The method of claim 1, wherein the interface is formed by at least partial removal of the first layer during the process.

11. The method of claim 10, wherein the interface comprises a boundary between the second layer and at least one selected from the group consisting of: the first layer, air, vacuum, slurry and combinations thereof.

12. The method of claim 1, wherein the interface is formed by deposition of the first layer on the second layer during the process, and wherein the interface comprises a boundary between the second layer and the first layer.

13. The method of claim 12, further comprising detecting, in the reflected light, a contribution of first-polarization light generated by the first layer that is distinguishable from a contribution from the second layer.

14. The method of claim 13, wherein the predefined criterion comprises the contribution from the first layer reaching a certain proportion of the reflected light.

15. The method of claim 1, wherein the light beam is directed onto the structure through at least one pinhole.

16. The method of claim 1, wherein the signal is generated to stop the performance of the process.

17. A computer program product tangibly embodied in an information carrier and comprising instructions that when executed by a processor perform a method for determining a property of a layered structure, the method comprising:
directing a light beam, during a process that changes a thickness of a first layer adjacent a second layer of a structure, onto the structure at a characteristic angle for the structure, the light beam including at least a first component having a first polarization and a second component having a second polarization, the characteristic angle being such that, after performance of the process, light reflected from a beam that impinges at the characteristic angle on an interface that will be formed adjacent the second layer has predominantly the first polarization;
detecting light that the structure reflects from the light beam; and
generating a signal upon detecting that a proportion of the reflected light that has the first polarization undergoes a change that meets a predefined criterion.

18. An apparatus for determining a property of a layered structure, the apparatus comprising:
a light source that directs a light beam onto a structure at a characteristic angle, the light beam including at least a first component having a first polarization and a second component having a second polarization, the characteristic angle being such that, after performance of a process that changes a thickness of a first layer adjacent a second layer of the structure, light reflected from the light beam impinging on an interface that will be formed adjacent the second layer has predominantly a first polarization;
a sensor that receives the reflected light; and
a processor configured to generate a signal upon detecting that a proportion of the reflected light that has the first polarization undergoes a change that meets a predefined criterion.

19. The apparatus of claim 18, wherein the first polarization is an s-polarization and the second polarization is a p-polarization, and wherein the change that meets the predefined criterion is an increase in the s-polarization as the interface is formed adjacent the second layer.

20. The apparatus of claim 18, wherein the light source directs the light beam onto the structure through at least one pinhole.

21. The apparatus of claim 18, wherein:
the first layer is a dielectric film on top of the second layer, the dielectric film to be at least partially removed in the process;
the interface that will be formed comprises a boundary between the second layer and at least one selected from the group consisting of: the first layer, air, vacuum, slurry and combinations thereof, and
the characteristic angle is a Brewster's angle for the interface.
